(19) United States
(12) Patent Application Publication
(10) Pub. No.: US 2020/0282652 A1
(43) Pub. Date: Sep. 10, 2020

(54) FLOW CONTROL IN A PNEUMATIC BUILD MATERIAL TRANSPORT SYSTEM

(71) Applicant: HEWLETT-PACKARD DEVELOPMENT COMPANY, L.P., Spring, TX (US)

(72) Inventors: David R. Otis, Jr., Corvallis, OR (US); Kevin E. Swier, Corvallis, OR (US); Jeffrey L. Thielman, Sant Cugat del Valles (ES)

(21) Appl. No.: 16/608,935

(22) PCT Filed: Nov. 11, 2017
(86) PCT No.: PCT/US2017/061199

§ 371 Date: Oct. 28, 2019

(51) Int. Cl. B29C 64/321; B65G 53/10; B65G 53/66

(52) U.S. Cl. CPC B29C 64/321; B33Y 40/00; B65G 53/66; B65G 53/10

(57) ABSTRACT

In one example, a pneumatic transport system to transport build material in an additive manufacturing machine includes a conduit, a source of air pressure to pull or push a stream of air through the conduit, a source of build material to introduce a build material into the stream of air, a separator to remove build material from the stream of air, a flow meter downstream from the separator to measure the stream of air flowing through the conduit, and a controller operatively connected to the flow meter and to the source of air pressure and/or the sources of build material to, based on a measurement from the flow meter, adjust a rate of flow of the stream of air in the conduit.

### BACKGROUND

Additive manufacturing machines produce 3D (three-dimensional) objects by building up layers of material. Some additive manufacturing machines are commonly referred to as “3D printers.” 3D printers and other additive manufacturing machines make it possible to convert a CAD (computer aided design) model or other digital representation of an object into the physical object. The model data may be processed into slices each defining that part of a layer or layers of build material to be formed into the object.

### DRAWINGS

FIG. 1 illustrates one example of a pneumatic transport system to transport build material in an additive manufacturing machine.

FIG. 2 is a block diagram illustrating one example of a controller in the pneumatic transport system shown in FIG. 1.

FIG. 3 is a flow diagram illustrating one example of a process to control the flow of build material in a pneumatic transport system such as that shown in FIG. 1.

FIG. 4 illustrates another example of a pneumatic transport system to transport build material in an additive manufacturing machine.

FIG. 5 is a section illustrating one example of a centrifugal separator in a pneumatic transport system such as that shown in FIG. 4.

FIG. 6 is an exploded isometric illustrating one example of a feed control mechanism in a pneumatic transport system such as that shown in FIG. 4.

FIG. 7 is a block diagram of a control system with a motor and motor controller such as might be used to control the rotational speed and position the example feed control mechanism shown in FIG. 6.

The same part numbers designate the same or similar parts throughout the figures.

### DESCRIPTION

In some additive manufacturing processes, powdered build materials are used to form a solid object. Particles in each of many successive layers of build material powder are fused in a desired pattern to form the object. Build material powder may be transported pneumatically to the build chamber in a stream of air. One of the challenges transporting powdered build material pneumatically is accurately controlling the rate of mass transfer to transport the desired quantity of powder to the build chamber, particularly when multiple build material powders are mixed together in the air stream during transport. If the rate of air flow is too slow, then build material powder introduced into the flow may settle out, reducing the rate of mass transfer and possibly clogging the flow conduit.

A new technique has been developed to help control the flow of powdered and other forms of build material in a pneumatic transport system in an additive manufacturing machine. In one example, a flow control process includes generating a stream of air with a blower or other source of air pressure, introducing a build material into the stream of air, separating the build material from the stream of air (to supply a build chamber), and measuring the rate of flow of the stream of air at a location downstream from where build material is separated from the air. If the flow rate falls below a threshold, then the rate of air flow is increased by reducing the amount of build material introduced into the stream of air and/or by increasing power to the blower. Also, it may be desirable in some circumstances to slow the rate of air flow based on measurements taken downstream from the separator, for example to increase the concentration of build material in the air stream. The rate of air flow may be slowed by increasing the amount of build material introduced into the stream of air and/or by decreasing power to the blower. Flow rates are measured downstream from the separator to help prevent inaccuracies or even fouling that may be caused by build material in the air flow upstream from the separator.

Examples are not limited to powdered build materials but may be used to help control the flow of other forms of pneumatically transported build materials including, for example, fibers and powder/fiber composites. The examples described herein illustrate but do not limit the scope of the patent, which is defined in the Claims following this Description.

As used in this document, “and/or” means one or more of the connected things; and a “memory” means any non-transitory tangible medium that can embody, contain, store, or maintain information and instructions for use by a processor and may include, for example, circuits, integrated circuits, ASICs (application specific integrated circuits), hard drives, random access memory (RAM), read-only memory (ROM), and flash memory.

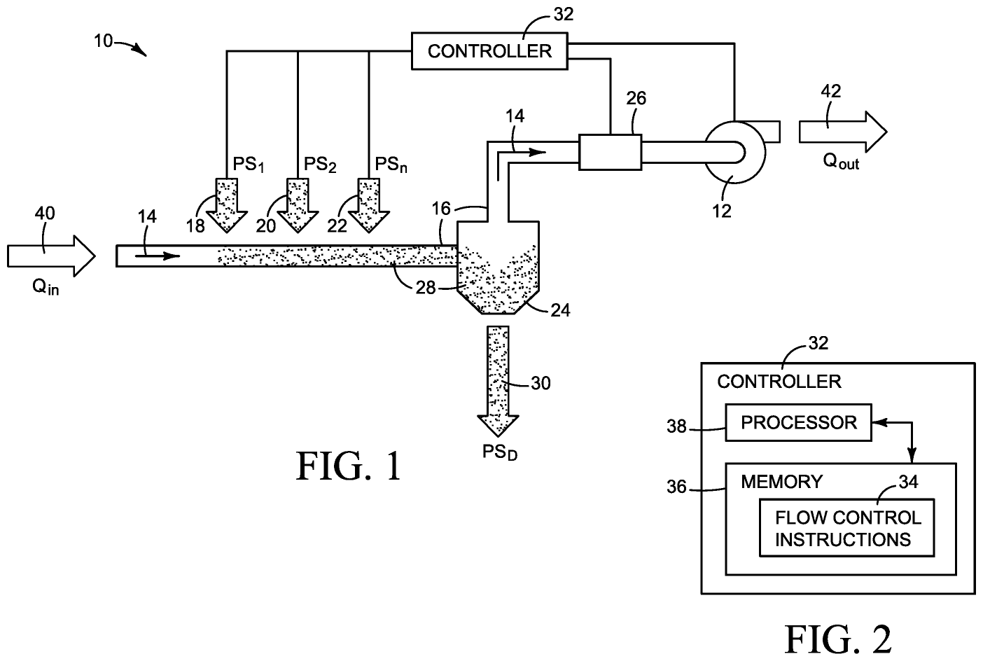

FIG. 1 illustrates one example of a pneumatic transport system 10 to transport build material in an additive manufacturing machine. Referring to FIG. 1, transport system 10 includes a blower or other source of air pressure 12 to pull or push a single stream of air 14 through a conduit 16. System 10 also includes multiple sources of build material 18, 20, 22, a separator 24 to remove build material from air stream 14, and a flow meter 26. The presence of build material in system 10 during operation is indicated by stippling 28 in FIG. 1.

Each build material source 18-22 is configured to introduce a build material into conduit 16 independent of the other sources. While three build material sources 18-22 are shown, any number of sources may be used, as indicated by the designation PS₁, PS₂ . . . PSₙ. Build materials mix in air stream 14 as they are carried to separator 24. Separator 24 removes build material from the air stream and discharges it to the build chamber or an intermediate component, as indicated by stippled arrow 30 (labeled PS_{D}). Flow meter 26 measures the flow rate of air stream 14 in conduit 16. Flow meter 26 is positioned downstream from separator 24 to prevent inaccuracies or even fouling that may be caused by build material 28 in conduit 16 upstream from separator 24. While any suitable flow meter may be used, it is expected that a venturi flow meter will be desirable in pneumatic transport systems for build materials in additive manufacturing because they produce little pressure loss, they hold calibration well, and they can be designed and “printed” (manufactured with a 3D printer) faster than other types of measuring devices.

A controller 32 is operatively connected to flow meter 26, air source 12, and build material sources 18-22. Controller 32 represents the programming, processing and associated memory resources, and the other electronic circuitry and components to control the transfer of build material 28 through conduit 16. In particular, controller 32 includes programming to adjust the rate of flow of air stream 14 in conduit 16 based on measurements from flow meter 24.

Referring to FIG. 2, flow control programming may be implemented, for example, through instructions 34 residing on a controller memory 36 for execution by a processor 38. Controller 32 may be implemented as a local controller for the flow control elements of transport system 10, as shown in FIG. 1, or as part of a larger system or machine controller. In one example, where the flow rate is controlled with the rate at which a build material is introduced into air stream 14, controller 32 may be implemented as a local device controller for one or more of the build material sources 18-22. In another example, where the flow rate is controlled with air pressure, controller 32 may be implemented as a local device controller for air source 12.

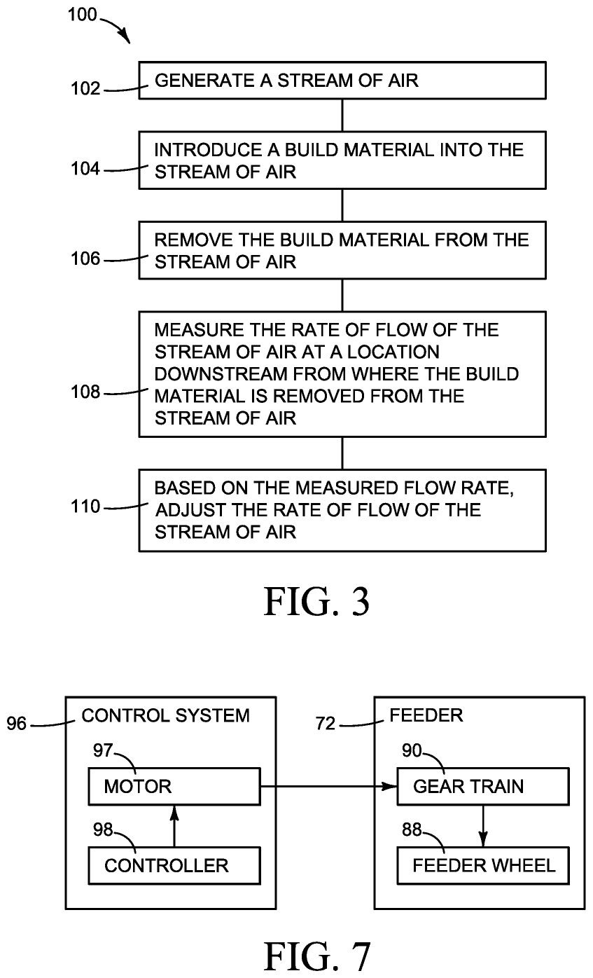

FIG. 3 is a flow diagram illustrating one example of a process 100 to control the flow of build material in transport system 10, for example by processor 38 in controller 32 executing flow control instructions 34. Part numbers in the description of process 100 refer to FIG. 1. Referring to FIG. 3, process 100 includes generating a stream of air (block 102), for example with an air pressure source 12 pulling air through a conduit 16, and introducing build material into the air stream (block 104), for example with one or more build material sources 18-22. Build material is removed from the air stream (block 106), for example with a separator 24, and the rate of air flow is measured downstream from where build material is removed from the air stream (block 108), for example with a flow meter 26. The rate of air flow is adjusted based on the measured rate of air flow (block 110), for example by adjusting the rate at which build material is introduced into the air stream at one or more supplies 18-22 and/or by adjusting the speed of a blower 12 to change the magnitude of the force pulling air through conduit 16.

Air flow rate is measured by flow meter 26 and build material feed rate is controlled at each source PS₁ through PSₙ. If the rate of air flow in stream 14 is too slow, build material will settle out of the air stream in horizontal runs of conduit 16. Thus, the rate of air flow may be monitored at meter 26 as build material is introduced into conduit 16 at one or more sources PS₁ through PSₙ and, if the rate of air flow falls to a threshold, then the rate of air flow may be increased by reducing the amount of build material introduced into the stream at one or more sources PS₁ through PSₙ and/or by increasing power to blower 12. Also, it may be desirable in some circumstances to slow the rate of air flow based on measurements from meter 26, for example to increase the concentration of build material in air stream 14. The rate of air flow may be slowed by increasing the amount of build material introduced into stream 14 at one or more sources PS₁ through PSₙ and/or by decreasing power to blower 12.

Referring again to FIG. 1, air enters conduit 16 at an intake 40, as indicated by arrow Qᵢₙ. Air leaves conduit 16 at a discharge 42, the exhaust of blower 12 in this example, as indicated by arrow Qₒᵤₜ. Conduit 16 in FIG. 1 represents the one or more conduits carrying air through system 10. In one example, a blower 12 pulls air through conduit 16. A negative pressure pulling air through conduit 16 may be desirable for transporting build material for additive manufacturing to help reduce the risk of build material leaking from transport system 10.

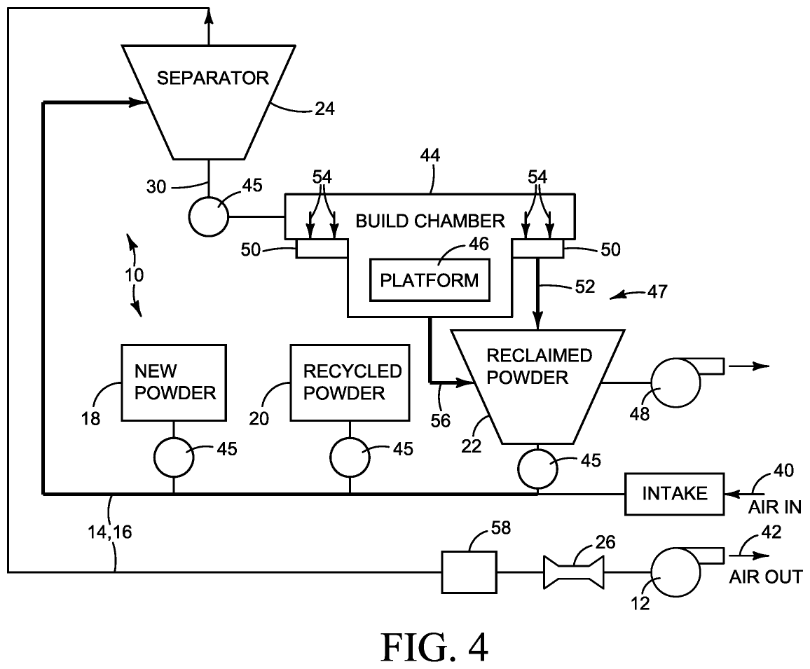

FIG. 4 illustrates another example of a pneumatic transport system 10 to transport build material in an additive manufacturing machine. Referring to FIG. 4, transport system 10 includes a blower 12 to pull a single stream of air 14 through a conduit 16, and a source of new build material 18, recycled build material 20, and reclaimed build material 22 to feed build material into air stream 14 in conduit 16. Arrows indicate the direction of air flow in FIG. 4. A feed control mechanism 45 may be used with each build material source to control the rate at which build material is introduced into conduit 16. Build material is removed from conduit 16 at a separator 24 and fed to a build chamber 44, for example through a feed control mechanism 45. Objects are formed on a platform 46 in build chamber 44. The presence of build material in conduit 16 during operation is indicated by a heavier line weight in FIG. 4.

Reclaimed build material source 22 is part of a reclamation subsystem 47 that includes a source of air pressure 48 to draw air and thus unused build material from the perimeter of build chamber 44 through a manifold 50 and conduit 52, as indicated by arrows 54, and from the bottom of build chamber 44 through a conduit 56. Reclaimed build material source 22 may be implemented, for example, as a separator to remove build material from conduits 52, 54 for feeding to conduit 16.

A filter 58 may be used ahead of flow meter 26 to remove any residual build material from air stream 14.

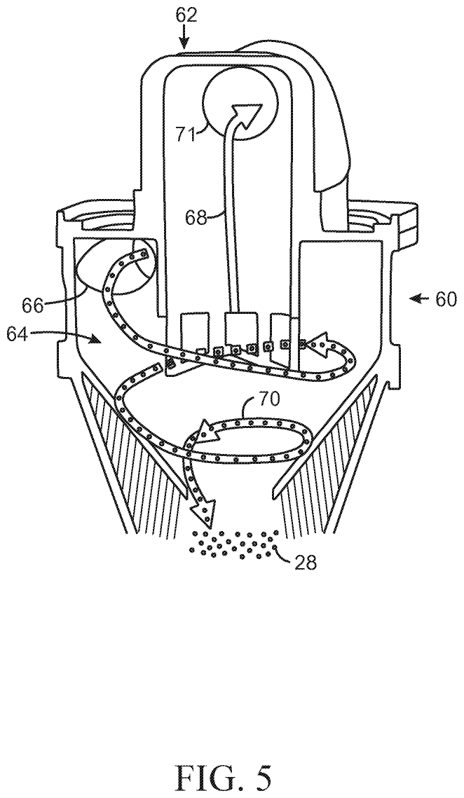

FIG. 5 illustrates one example of a centrifugal separator 60 such as might be used for separator 24 and separator 22 in a transport system 10 shown in FIG. 4. Referring to FIG. 5, separator 60 includes an inner portion 62 and an outer portion 64. The air and build material mix enters separator 60 at intake 66. The shape of inner portion 62 creates a vortex in the middle of the separator that causes the lighter air to flow upward (see air path arrow 68) while the heavier build material flows downward and spreads centrifugally toward the walls of the separator (see build material path 70). This causes build material 28 to drop down and out of the separator, into a feed control mechanism 45 (FIG. 4) or a container intermediate to the feed control mechanism, while the air flows up and out of the separator at outflow 71.

Each separator 24, 22 in FIG. 4 may be implemented as a single centrifugal separator 60 or multiple separators 60 arranged in parallel. The efficiency of centrifugal separation may vary based on the size and density of the particles or fibers in the build material, the speed of the conveying air stream, geometrical factors, and static cling. Centrifugal separation with one or more separators 60, for example, may be capable of separating at least 99.95% of build material powder from the incoming air stream for particle size 60-80 microns, at least 99.9% for particle size 45-60 microns, and 99.5% for particle size 10-20 microns. For build material powder particles smaller than 10 microns (known as “fines”), separator 60 is designed to minimize or reduce the fines in the air outflow stream 68.

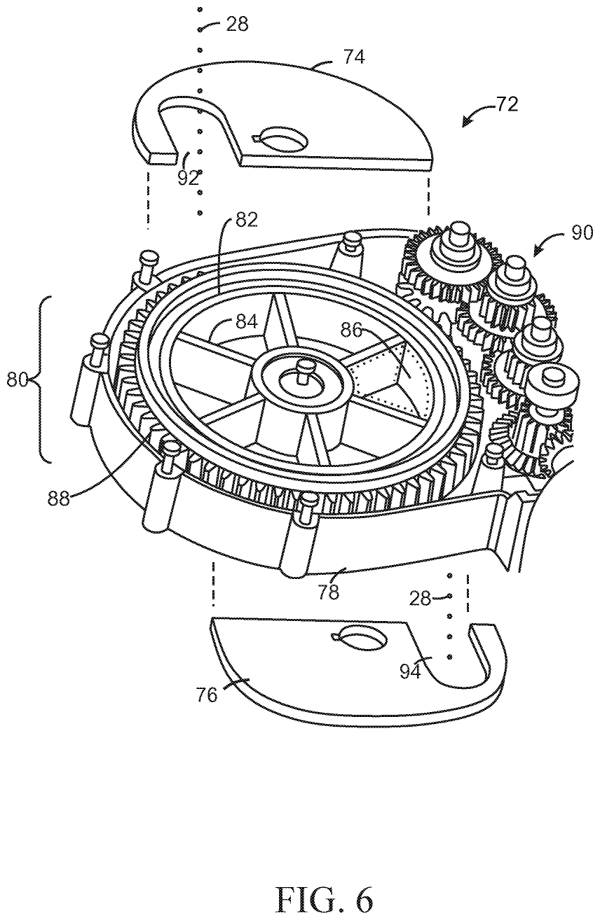

FIG. 6 illustrates one example of a feeder 72 such as might be used for each feed control mechanism 45 in a transport system 10 shown in FIG. 4. Referring to FIG. 6, feeder 40 includes an upper shoe 74, a lower shoe 76, and a housing 78 sandwiched orthogonally between shoes 74, 76. A chamber 80 inside housing 78 is made up of a circular rim 82 and spokes 84, which form distinct pockets 86. In the example shown in FIG. 6, chamber 80 includes six spokes 84 and six pockets 86 of equal size. In one example, chamber 80 includes at least three spokes 84 and three pockets 86. In one example, the number of pockets 86 is great enough and thus the volume of each pocket small enough to keep air upflow from an empty pocket below a performance inhibiting threshold, 0.1 m/sec for example. In one example, the volume of each pocket 86 is 4-10 cubic centimeters.

A circular wheel gear 88 surrounding pockets 86 is operatively connected to a drive motor (FIG. 7) through a gear train 90 to selectively rotate chamber 80. Build material powder may enter feeder 72 through an inlet 92 in upper shoe 74 and leave through an outlet 94 in lower shoe 76. Upper shoe 74 is sealed against the top surface of rim 82 and spokes 84 and lower shoe 76 is sealed against the bottom surface of rim 82 and spokes 84, to seal chamber 80 and pockets 86 except at inlet 92 and outlet 94. Inlet 92 and outlet 94 are diametrically opposed or otherwise arranged on shoes 74, 76, respectively, so that the same pocket 86 is not open to both inlet 92 and outlet 94 at the same time and so that there is at least one spoke-to-shoe seal between inlet 92 and outlet 94. Thus, air pressure upstream of feeder 72 is isolated from air pressure downstream of feeder 72. Build material 28 drops into a pocket 86 as it is rotated into position under inlet 92 and drops out of a pocket 86 as it is rotated into position over outlet 94. Feeder 72 inhibits air backflow into separator 24, 22 and conduit 16 by fluidically isolating downstream air entering a pocket 86 through outlet 94 during a build material drop from upstream air at inlet 92.

In the example shown in FIG. 6, inlet 92 and outlet 94 are the same size and shape, but these openings may be dissimilar in shape and size.

As shown in the block diagram of FIG. 7, a control system 96 with a motor 97 and motor controller 98 may be used to control the rotational speed and position of pockets 86 in feeder 72 to alternately fill and empty each pocket 86 at the desired rate. Motor controller 98 represents the programming, processing and associated memory resources, and the other electronic circuitry and components to control motor 97 to achieve the desired feed rate of build material through feeder 72. For example, chamber 80 may be rotated faster to increase the feed rate or slower to decrease the feed rate, for example in response to air flow measurements as described above. Controller 98 may be implemented as a local controller for feeder motor 97, as shown in FIG. 7, or as part of a transport system or additive manufacturing machine controller.

As noted at the beginning of this Description, the examples shown in the figures and described above illustrate but do not limit the scope of the patent. Other examples are possible. Therefore, the foregoing description should not be construed to limit the scope of the patent, which is defined in the following Claims.

“A” and “an” as used in the Claims means one or more.

1. A pneumatic transport system to transport build material in an additive manufacturing machine, the system comprising:
a conduit;
a source of air pressure to pull or push a stream of air through the conduit;
a source of build material to introduce a build material into the stream of air;
a separator to remove build material from the stream of air;
a flow meter downstream from the separator to measure the stream of air flowing through the conduit; and
a controller operatively connected to the flow meter and to the source of air pressure and/or the source of build material to, based on a measurement from the flow meter, adjust a rate of flow of the stream of air in the conduit.

2. The system of claim 1, where the source of build material comprises multiple sources of build material each to introduce a build material into the stream of air independent of any other of the sources.

3. The system of claim 2, where:
the source of air pressure is to pull or push a single stream of air through the conduit;
the multiple sources of build material are each to introduce a build material into the single stream of air independent of any other of the sources;
the separator is to remove build material from the single stream of air;
the flow meter is to measure the single stream of air flowing through the conduit; and
the controller is to adjust the rate of flow of the single stream of air in the conduit by adjusting a rate at which a build material is introduced into the single stream of air and/or the magnitude of a force with which air is pulled or pushed through the conduit.

4. The system of claim 3, where the flow meter comprises a venturi flow meter in line with the conduit.

5. The system of claim 4, comprising a filter between the separator and the flow meter to filter build material out of the single stream of air.

6. The system of claim 2, where each source of build material includes a feeder to control the rate at which build material is introduced into the conduit and to isolate air pressure upstream of feeder from air pressure downstream of feeder.

7. The system of claim 6, where each feeder comprises:
a rotatable chamber having multiple pockets;
an upper shoe covering a top part of the chamber;
an inlet in the upper shoe through which build material may enter the pockets;
a lower shoe covering a bottom part of the chamber;
an outlet in the lower shoe through which build material may leave the pockets; and
the inlet and the outlet arranged in the shoes so that each pocket is never simultaneously below the inlet and above the outlet.

8. A memory having instructions thereon that when executed cause a pneumatic build material transport system in an additive manufacturing machine to:
generate a single stream of air;
introduce a build material into the single stream of air at a first location;
remove build material from the single stream of air at a second location downstream from the first location;
measure a rate of flow of the single stream of air at a third location downstream from the second location; and
based on a measured rate of flow of the single stream of air, adjust the rate at which build material is introduced into the single stream of air and/or the magnitude of a force used to generate the single stream of air.

9. The memory of claim 8, where the instructions to introduce a build material into the single stream of air at a first location include instructions to introduce each of multiple build materials into the single stream of air at respective first locations upstream from the second location.

10. The memory of claim 8, where the instructions to generate a single stream of air include instructions to pull air through a conduit.

11. A controller implementing the memory of claim 8.

12. A flow control process for a pneumatic build material transport system in an additive manufacturing machine, the process comprising:
pulling air through a conduit in a stream of air;
introducing a build material into the stream of air;
removing the build material from the stream of air;
measuring a rate of flow of the stream of air at a location downstream from where the build material is removed from the stream of air; and
based on the measuring, adjusting the rate of flow of the stream of air by changing a rate at which the build material is introduced into the stream of air and/or by pulling harder on the air.

13. The process of claim 12, where the introducing includes introducing each of multiple build materials into the stream of air at different locations.

14. The process of claim 12, where the introducing includes introducing the build material into the stream of air at a controlled rate.
